(19) United States
(12) Patent Application Publication
(10) Pub. No.: US 2004/0201994 A1
(43) Pub. Date: Oct. 14, 2004

(54) Redesign of cobra luminaire

(76) Inventor: Samuel Matthew Neely, Los Angeles, CA (US)

Correspondence Address: Samuel Matthew Neely, 8636 Graham Avenue, Los Angeles, CA, 90002, US

(21) Appl. No.: 10/410,523

(22) Filed: Apr. 10, 2003

(51) Int. Cl. F21V 7/00

(52) U.S. Cl. 362/296

(57) ABSTRACT

By altering the assembly of the material presently used in the existing Cobra luminaries, results in additional light output, human see ability and substantial power savings that can substantially improve the use of this light source

### BACKGROUND OF THE INVENTION

The Cobra-type lighting was designed approximately 50 years ago. Now, the Cobra-type luminaire is used around the world. And the advantages available in today's designs of the Cobra-type luminaire provide a great deal of power savings. However, this improved upon invention, when employed saves even more power (or energy). Clearly many millions of dollars in the cost of power will be saved. At one time high-pressure sodium was considered the most efficient light source known because it produced more lumens per watt than incandescent light sources. When the Cobra design was made, there was no consideration regarding the see-ability in the result of using this light source.

A great percentage of light produced by high-pressure sodium is beyond human use. My invention corrects this error.

The street lighting industry has made great strides regarding the improvement in lighting various outdoors signage, streets and fields. My invention will further improve the industry by reducing light pollution and preventing the waste of energy. Therefore, the existing cobra light fixture design will be more efficient in light output using this inventive design. Because of the changes made in the composition of the sodium halide, and the different shaped light bulb will cause the light to illuminate the designated target with minimum spillover light into the surrounding atmosphere.

### BRIEF SUMMARY OF THIS INVENTION

This invention is that of the Cobra redesign relating to the street lighting type of luminaire presently used in the illumination of streets and byways in the world. The steel poles or support structures for mounting the units above grade are not included in this invention and will remain as is now being used.

This invention is a light source that would no longer pollute the sky with excess wasted light. Henceforth it has been common, if not universal practice, to illuminate the heavens with wasted light. Light will travel to infinity unless it is absorbed or redirected. The telescopes across the world can no longer study the stars at night because of this light pollution. Street lighting is only a part of this major problem. As an example, the beams from street lighting floodlights can be seen from flying aircraft flying high overhead. Approximately fifty percent of the precious oil purchased for electrical energy being shipped to American shores is now being wasted in light pollution lighting up the sky. England suffered from the same problem of power waste, and solved this problem by introducing conservativeness. So can America, partially through this invention.

Using the results of this invention, a conservative estimate, would be that the power to be saved would be a minimum of fifty percent of that which is presently used. In this day of power cost this will amount to a very substantial dollar saving, and then, also, save precious power.

### BRIEF DESCRIPTION OF THE SEVERAL VIEWS OF THE DRAWING

FIG. 1 depicts the existing Cobra design, as it is being using in today's market.

FIG. 2 depicts the design of the Cobra according to this invention.

FIG. 3 depicts Cobra using the mercury vapor lamp bulb.

FIG. 4 depicts an installed view of an existing Cobra design as seen from the street. (This includes any alterations made in the glass filter (location 7 FIG. 1.)

FIG. 5 depicts an installed view of the Cobra luminaire using a seal beam (location 15 FIG. 2) lamp bulb according to this invention when viewed from the street.

### DETAILED DESCRIPTION OF THE INVENTION

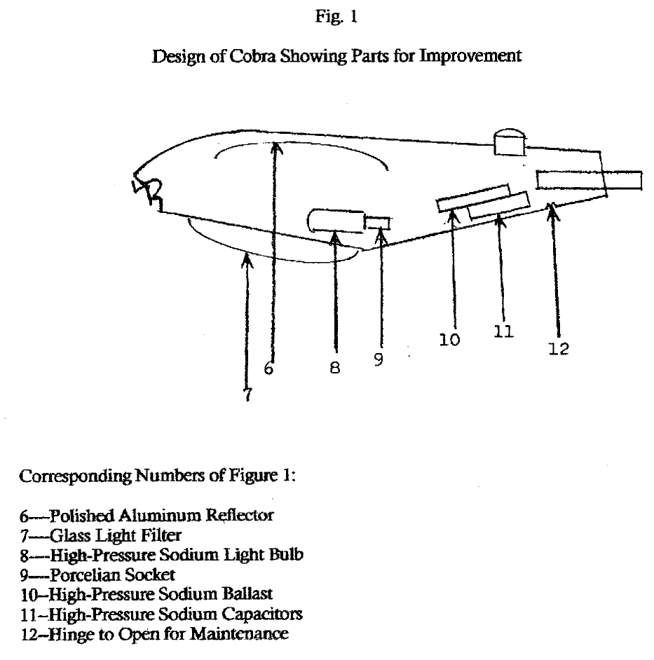

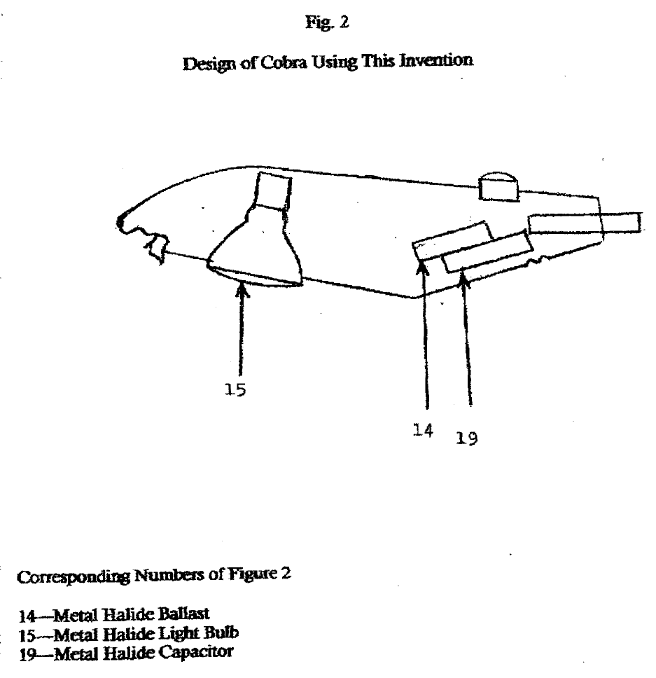

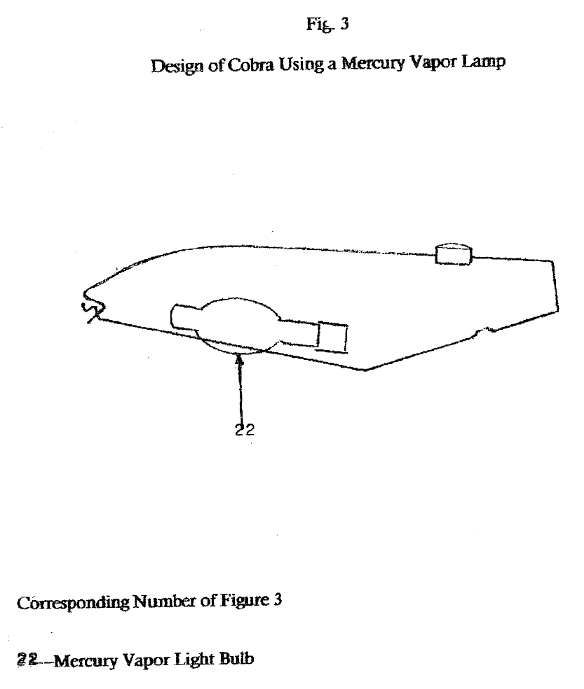

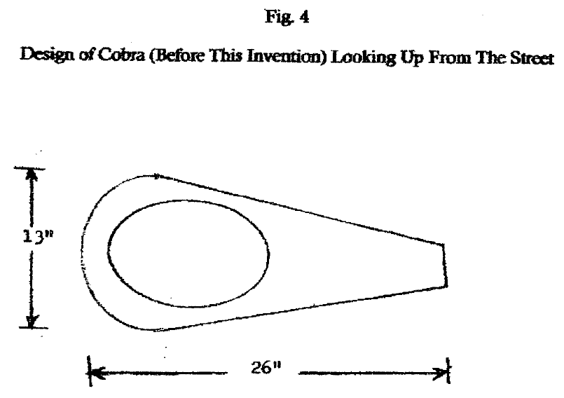

1. Lamp bulb change type high-pressure sodium (location number 8 FIG. 1) to (location 15 FIG. 2). This bulb change design will change the see-ability of a product under the light, because high pressure sodium creates a beam of light that's not within in the human eye sensitive portion of the spectrum. Therefore, objects are dull and not bright for human need. The metal halide produces a beam of light that is well within the human eye-sensitive portion of the spectrum. Therefore, where an object may not be seen with high-pressure sodium, will be well viewed by the light produced by metal halide.

2. Reflector (location 6 FIG. 1) No reflector, or light filter, produces light lumens. The reflector, or light filter only absorb the light from the light bulb. The more the light is reflected, or filtered, the less light lumen output the product produces. The size of the reflector in this invention is at lease five times less surface to absorb the light lumens.

3. Light filter (location 7 FIG. 1). This new invention does not require a filter that reduces the production of light. The lamp bulb (location 15 FIG. 2) is clear hard glass that does not require any additional filter to make the product weatherproof. The lamp bulb will withstand all weather conditions of severity.

4. Fuse and fuse holder (location 18 FIG. 2) The fuse protects the electrical line, capacitor, transformer, and lamp bulb.

5. Ballast and capacitor (location 10 FIG. 1; location 11 FIG. 1; location 14 FIG. 2; location 19 FIG. 2) Changing these two items is only necessary if the user wishes to improve the see-ability from the light source. High-pressure sodium provides light beams beyond the eye-sensitive portion of the spectrum. Whereby metal halide produces light in the full spectrum of the human sight.

6. The hinge (location 12 FIG. 1), remains the same as it is now used to service luminaire interior. With this new invention, it is not necessary to open the luminaire to change the light bulb.

7. Enclosure cover (location 16 FIG. 2) is designed to close the opening that was before covered with a glass filter (location 7 FIG. 1) Since this glass filter is eliminated it is necessary to create an enclosure cover (location 16 FIG. 2).

8. To change the light bulb (location 8 FIG. 1; location 15 FIG. 2) with this new invention, merely unscrew the light bulb from the socket, working externally. Whereas to change the high-pressure sodium lamp bulb (location 8 FIG. 1) it is necessary to open the fixture to remove the burned-out light bulb (location 8 FIG. 1), next replace it with a new light bulb (location 8 FIG. 1), then close the housing.

There are four purposes of this invention: 1) to increase the floodlight lumen output; 2) decrease the power consumed; 3) produce light beams that are within the human eye sensitive portion of the spectrum, and 4) fuse (location 18 FIG. 2) the floodlight to further reduce the maintenance costs to the consumer. With this new invention the housing of the electrical parts (location 23 FIG. 2) would no longer act as a trap to block the production of light from the luminaire to the target area.

What my claim as my invention is:

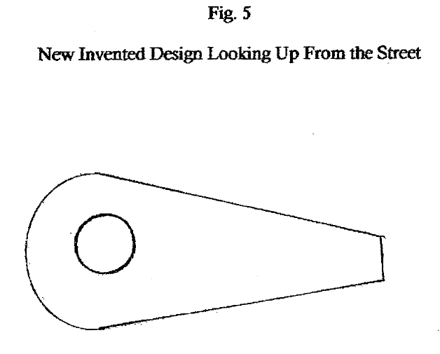

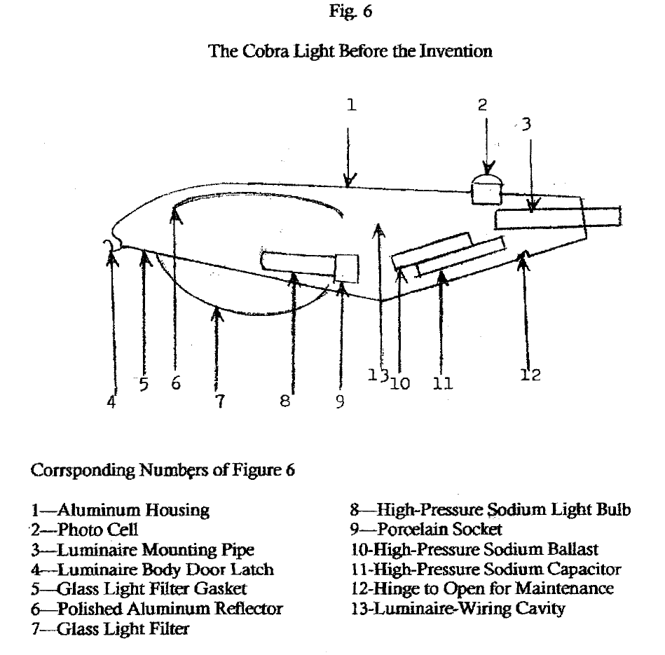

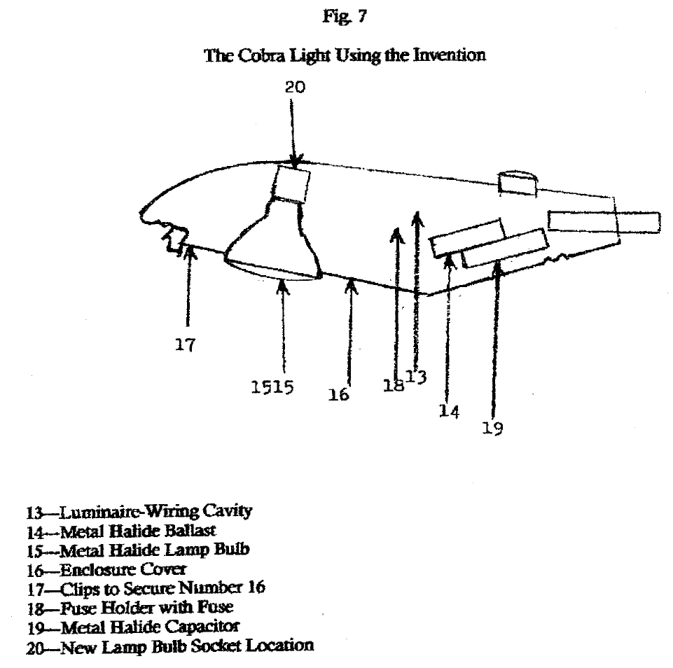

1. A new electrical design of parts used in the existing COBRA luminaries and the light bulb socket (location 19 FIG. 5) will be to shoot light on a vertical plane instead of a horizontal plane with socket (location 9 FIG. 6) and to change the light bulb (location 8 FIG. 6) from High Pressure Sodium to Metal Halide (location 15 FIG. 5) to substantially improve the see ability, to increase the volume of light on the target area by eliminating the reflector (location 6 FIG. 6) and glass filter (location 7 FIG. 6) and to reduce the light pollution 50 percent.
